(19) United States
(12) Patent Application Publication
(10) Pub. No.: US 2011/0079586 A1
(43) Pub. Date: Apr. 7, 2011

(54) Method and Apparatus for Manufacturing Coreless Armature

(75) Inventors: Keiichi Kubota, Kanagawa (JP); Akira Kitajima, Kanagawa (JP); Tatsumune Miyazaki, Kanagawa (JP); Takashi Furuhata, Kanagawa (JP)

(73) Assignee: SHICOH CO., LTD., Kanagawa (JP)

(21) Appl. No.: 12/892,275

(22) Filed: Sep. 28, 2010

(30) Foreign Application Priority Data
Oct. 1, 2009 (JP) 2009-229513

(51) Int. Cl. B23K 11/24

(52) U.S. Cl. 219/108; 219/117.1

(57) ABSTRACT

A method for manufacturing a coreless armature, which can prevent a short circuit of adjacent terminal layers when resistance-welding the terminal layers, is provided. In a method for manufacturing a coreless armature, terminals 5 of the conducting bands 3 provided to each coil base 1 are stacked to form a terminal layer 23, a welding rod 21 is pressed against a terminal positioned on an outermost periphery so as to interpose the terminal layer 23 between coil jigs 9a and 9b and the welding rod 21, and an electric current is applied thereto, thereby connecting each terminal 5 of the terminal layer 23 by way of resistance welding, in which an insulating material 25 is arranged between terminal layers 23 adjacent in a circumferential direction to resistance-weld the terminal layers 23.

This application is based on and claims the benefit of priority from Japanese Patent Application No. 2009-229513, filed on 1 Oct. 2009, the content of which is incorporated herein by reference.

### BACKGROUND OF THE INVENTION

1. Field of the Invention

The present invention relates to a method and apparatus for manufacturing a coreless armature used as a rotor in a generator or a motor.

2. Related Art

Patent Document 1 discloses that coil bases, on which a multitude of conducting bands are formed in parallel, are concentrically arranged via insulating layers; and thereafter, terminals of the conducting bands provided to each coil base are stacked to form a terminal layer; and the terminal layers arranged at intervals in a circumferential direction are sequentially connected by way of soldering or resistance welding.
Patent Document 1: Japanese Unexamined Patent Application Publication No. 2002-542749 (Translation of PCT International Application Publication No. WO 00/62402)

### SUMMARY OF THE INVENTION

However, in the technique of Patent Document 1, since the interval of the terminal layers adjacent in a circumferential direction is narrow, the solder may scatter (splash) or flow out when soldering, which may result in a short circuit of the adjacent terminal layers.

On the other hand, when the terminal layers are connected by way of resistance welding, although the inconvenience in the case of soldering can be eliminated, a terminal of the terminal layers may be dislocated when the welding rod is pressed against it, the terminal area may spread due to the pressure of the welding rod (spreading terminal), or the terminal metal may splash, resulting in a short circuit of the adjacent terminal layers. Furthermore, when the resistance welding is performed, the Fleming force may operate due to an electric current applied to the terminal layers, and a terminal may be dislocated from the terminal layers, resulting in a short circuit by contacting with the adjacent terminal layers.

Therefore, an object of the present invention is to provide a method for manufacturing a coreless armature, which can prevent a short circuit of adjacent terminal layers when resistance welding of the terminal layers is performed.

The present invention has been made in view of the aforementioned circumstances, and a method for manufacturing a coreless armature according to a first aspect of the present invention is characterized in a method for manufacturing a coreless armature, in which each terminal of terminal layers is connected by way of resistance welding, the method includes the steps of: arranging a plurality of coil bases concentrically via insulating layers to a cylindrical coil jig, a multitude of conducting bands being formed on the coil bases in parallel; forming a terminal layer by stacking terminals of the conducting bands provided to each coil base; pressing a welding rod against a terminal positioned on an outermost periphery of the terminal layer so as to interpose the terminal layer between the coil jig and the welding rod; and applying an electric current between the coil jig and the welding rod, in which an insulating material is arranged between terminal layers adjacent in a circumferential direction to resistance-weld the terminal layers.

According to the first aspect of the present invention, since the insulating material is arranged between the adjacent terminal layers, when the terminal layers are resistance-welded, the terminals can be prevented from being dislocated and touching the adjacent terminal layers due to a pressing force of the welding rod pressing the terminal layer, and the Fleming force when applying an electric current. Similarly, even in a case in which the terminal area spreads or the terminal metal splashes due to the pressure of the welding rod, the insulating material restricts, or serves as a wall against, the spreading of the terminal area, and prevents the splashed metal from contacting the adjacent terminal layers, a result of which a short circuit of the adjacent terminal layers can be prevented.

Since this can increase the pressing force of the welding rod and increase the electric current for the resistance welding, the terminal layers can be rigidly connected.

In the first aspect, it is preferable that the insulating material arranged between the terminal layers can be inserted and removed freely.

As a result, the insulating materials arranged between the terminal layers may be arranged on only both sides of the terminal layer that is welded; therefore, the amount of the insulating materials to be used can be reduced.

Furthermore, in the step of pressing the welding rod against the terminal layer, it is preferable that the insulating material is inserted between terminal layers.

As a result, the insulating material may be arranged on only both lateral sides of a portion that is welded by the welding rod.

Furthermore, it is preferable that the insulating material is fixed to both lateral sides of the welding rod.

As a result, with such a simple configuration, the insulating materials can be automatically inserted into both sides of the terminal layer to be welded in synchronization with the descending of the welding rod.

A second aspect of the present invention is an apparatus for manufacturing a coreless armature, and the apparatus includes: a cylindrical coil jig, on which a plurality of coil bases are concentrically arranged via insulating layers, a multitude of conducting bands being formed on the coil bases in parallel; a welding rod that is pressed against a terminal positioned on an outermost periphery of a terminal layer in which terminals are stacked; and an insulating material arranged between adjacent terminal layers, in which an electric current is applied between the coil jig and the welding rod to connect each terminal of the terminal layers by way of resistance welding.

According to the second aspect, an apparatus for manufacturing a coreless armature that achieves the operation and effect similar to those of the first aspect can be provided.

In the second aspect, it is preferable that the insulating material is fixed to both lateral sides of the welding rod. As a result, with such a simple configuration, the insulating materials can be automatically inserted into both sides of the terminal layer to be welded in synchronization with the descending of the welding rod.

### BRIEF DESCRIPTION OF THE DRAWINGS

FIG. 1 is a perspective view showing a state in which a terminal layer is resistance-welded, in a method for manufacturing a coreless armature according to a first embodiment;

FIG. 2 is a perspective view showing a coil base in a developed manner that is used in the first embodiment;

FIG. 3 is an exploded perspective view showing a state in which coil bases are concentrically arranged;

FIG. 4 is a perspective view showing a state in which insulating materials are arranged between terminal layers;

FIG. 5 is a cross-sectional view showing a portion of the coreless armature; and

FIG. 6 is a front view showing terminal layers and a welding rod, in a method for manufacturing a coreless armature according to a second embodiment.

### DETAILED DESCRIPTION OF THE INVENTION

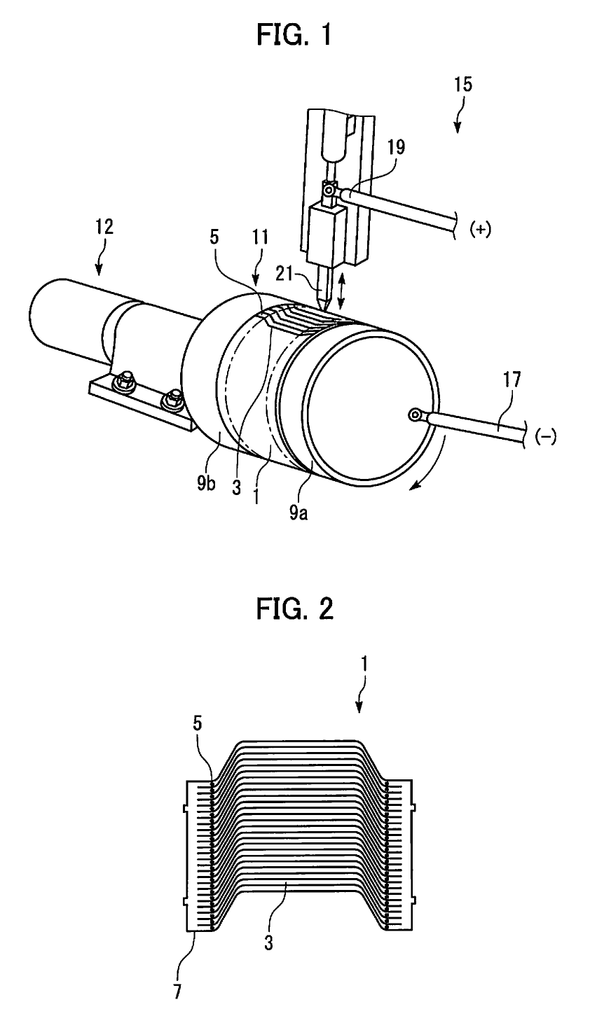

A first embodiment of the present invention is hereinafter described in detail with reference to FIGS. 1 to 5. Firstly, an apparatus for manufacturing a coil base and a coreless armature used for the present embodiment is described. It should be noted that the coreless armature according to the present embodiment is used as a rotor in a generator.

As shown in FIG. 2, a multitude of conducting band 3 are formed in parallel at intervals on a coil base 1, and each terminal 5 of each conducting band is connected together by way of a side edge portion 7. The conducting bands 3 are formed at intervals on the coil base 1 by etching or pressing a copper plate.

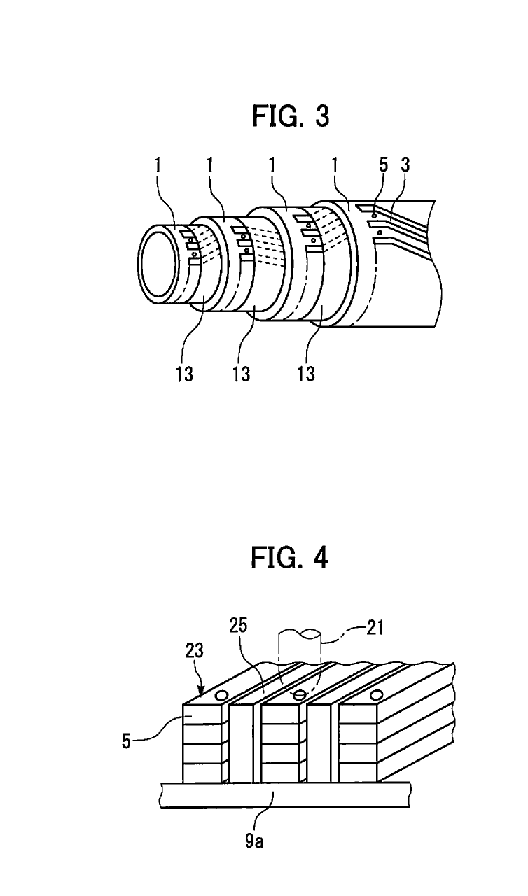

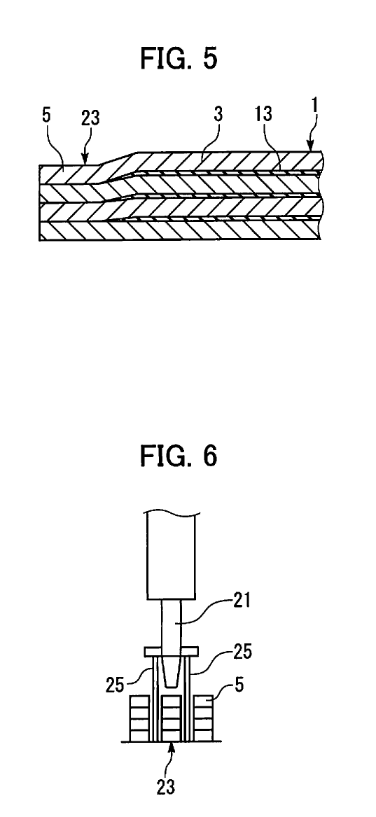

As shown in FIGS. 1 and 3, the coil base 1 has a cylindrical shape by binding ends thereof to cylindrical coil jigs 9a and 9b, and is coiled as a plurality of layers in a concentric circular manner. An insulating resin material 13 (see FIGS. 3 and 5) is interposed between each coil base 1, and adjacent and concentric coil bases 1 and 1 are insulated from each other. It should be noted that, in the present embodiment, four coil bases 1 are coiled as four layers, and as shown in FIGS. 3 and 5, the insulating resin material 13 is not provided to a portion of the terminals 5 of the conducting bands 3.

Each coil base 1 is separated by cutting the side edge portion 7 after coiling in a cylindrical shape, so that adjacent conducting bands 3 are insulated.

A coil body 11, which is formed by coiling the coil bases 1 as four layers between the coil jigs 9a and 9b and removing the side edge portion 7 as described above, is mounted to an index device 12, and the terminals 5 of the conducting bands 3 of the coil bases 1 stacked as four layers are resistance-welded.

As shown in FIG. 1, a resistance welder 15 is provided beside the index device 12; the resistance welder 15 includes an electrode (negative electrode) 17 connected to the coil jig 9a, and a welding rod 21 connected to a positive electrode 19; and the welding rod 21 is provided so as to move freely in a vertical direction.

Next, a resistance welding method in the present embodiment is described. As shown in FIGS. 4 and 5, in end portions of the cylindrical coil body 1, the terminals 5 of the conducting bands 3 of each layer are stacked as four layers to form terminal layers 23, and the terminal layers 23 are arranged at intervals in a circumferential direction of the coil jigs 9a and 9b. An insulating material 25 such as ceramics or a phenol-aldehyde resin material is arranged between adjacent terminal layers 23. The insulating material 25 may be arranged between the adjacent terminal layers 23 and 23, may be arranged between the terminal layers 23 with a gap, or may be fit between the terminal layers 23 and 23 with almost no gap.

In the present embodiment, the insulating material 25 is removable, and is removed after welding the terminal layers 23.

In addition, the insulating material 25 is arranged between the terminal layers 23 and 23, the welding rod 21 is descended, the topmost terminal 5 is pressure-welded, and an electric current is applied thereto, thereby welding the stacked terminal layers 23.

In this way, after having welded the terminal layers 23, the coil body 11 is rotated a predetermined angle by way of the index device 12, and all the terminal layers 23 are sequentially welded along the circumferential direction in sequence.

It should be noted that, when the terminal layers 23 on one end side of the coil body 11 have been welded over the entire perimeter, the coil body 11 is removed from the index device 12 to replace the end of the coil body 11, and is mounted to the index device again, and the terminal layers 23 on another end side of the coil body 11 are welded, similarly to the one end side.

After all the terminal layers 23 have been welded, the coil jigs 9a and 9b are removed from the coil body 11, then the coreless armature coil is finished.

According to the present embodiment, the insulating material 25 is arranged between the adjacent terminal layers 23 and 23 when the terminals 5 of the coreless armature are resistance-welded; therefore, when the terminal layers 23 are resistance-welded, the terminals 5 can be prevented from being dislocated and touching the adjacent terminal layers 23 due to a pressing force of the welding rod 21 pressing the terminal layer 23 and the Fleming force caused by an electric current. Similarly, even in a case in which the terminal area spreads or the terminal metal splashes due to the pressure of the welding rod 21, the insulating material 25 can prevent a short circuit due to contact of the adjacent terminal layers 23.

Furthermore, the pressing force of the welding rod 21 can be increased, and the electric current for the resistance welding can be increased; therefore, the terminal layers 23 can be rigidly connected.

Although another embodiment of the present invention is described below, in the embodiment to be described below, portions that achieve the same operation and effect as those in the aforementioned embodiment are assigned with the same reference symbols, thereby omitting the detailed descriptions of the portions, and points that are different from the aforementioned embodiment are mainly described in the embodiment to be described below.

A second embodiment is described with reference to FIG. 6. In the second embodiment, the insulating materials 25 and 25 are fixed to both lateral sides of the welding rod 21, and when the welding rod 21 descends to weld one terminal layer 23, the insulating materials 25 are located on both sides of the terminal layer 23 that should be welded, and when the welding rod 21 ascends after the welding, the insulating materials 25 and 25 ascend from between the terminal layers 23 and 23, and are removed therefrom.

According to the second embodiment, the operation and effect similar to those of the first embodiment are achieved, and in addition, the insulating materials 25 arranged between the terminal layers 23 and 23 may be arranged on only both sides of the terminal layer 23 to be welded; therefore, the amount of the insulating materials 25 to be used can be reduced.

Moreover, since the insulating materials 25 and 25 are fixed to the welding rod 21, with such a simple configuration, the insulating materials 25 and 25 can be automatically inserted into both sides of the terminal layer 23 to be welded in synchronization with the descending of the welding rod.

The present invention is not limited to the aforementioned embodiments, and various modifications are possible within a range that does not depart from the spirit of the present invention. For example, in the second embodiment, without limitation to the insulating materials 25 and 25 being fixed to the welding rod 21, a configuration may be employed, in which an insulating material insertion mechanism for inserting the insulating material 25 is provided in addition to the welding rod 21, and the insulating materials 25 and 25 are arranged on both sides of the terminal layer 23 in synchronization with the vertical movement of the welding rod.

In the first embodiment, the insulating materials 25 may be left as they are after all the terminal layers 23 have been welded.

The coil base 1 is not limited to being arranged as four layers, and may be arranged as two layers, three layers or five layers, and the number of layers is not limited as long as being stacked as a plurality of layers.

What is claimed is:

1. A method for manufacturing a coreless armature, in which each terminal of terminal layers is connected by way of resistance welding, the method comprising the steps of:
arranging a plurality of coil bases concentrically via insulating layers to a cylindrical coil jig, a multitude of conducting bands being formed on the coil bases in parallel;
forming a terminal layer by stacking terminals of the conducting bands provided to each coil base;
pressing a welding rod against a terminal positioned on an outermost periphery of the terminal layer so as to interpose the terminal layer between the coil jig and the welding rod; and
applying an electric current between the coil jig and the welding rod,
wherein an insulating material is arranged between terminal layers adjacent in a circumferential direction to resistance-weld the terminal layers.

2. The method for manufacturing a coreless armature according to claim 1, wherein the insulating material arranged between the terminal layers can be inserted and removed freely.

3. The method for manufacturing a coreless armature according to claim 2, wherein, in the step of pressing the welding rod against the terminal of the terminal layer, the insulating material is inserted between terminal layers laterally adjacent to the terminal layer to be pressed.

4. The method for manufacturing a coreless armature according to claim 3, wherein the insulating material is fixed to both lateral sides of the welding rod.

5. An apparatus for manufacturing a coreless armature, the apparatus comprising:
a cylindrical coil jig, on which a plurality of coil bases are concentrically arranged via insulating layers, a multitude of conducting bands being formed on the coil bases in parallel;
a welding rod that is pressed against a terminal positioned on an outermost periphery of a terminal layer in which terminals are stacked; and
an insulating material arranged between adjacent terminal layers,
wherein an electric current is applied between the coil jig and the welding rod to connect each terminal of the terminal layers by way of resistance welding.

6. The apparatus for manufacturing a coreless armature according to claim 5, wherein the insulating material is fixed to both lateral sides of the welding rod.
